(19) United States
(12) Patent Application Publication
(10) Pub. No.: US 2022/0180174 A1
(43) Pub. Date: Jun. 9, 2022

(54) USING A DEEP LEARNING BASED SURROGATE MODEL IN A SIMULATION

(71) Applicant: International Business Machines Corporation, Armonk, NY (US)

(72) Inventors: Ambrish Rawat, Dublin (IE); Fearghal O'Donncha, Aran Islands (IE); Mathieu Sinn, Dublin (IE); Sean A. McKenna, Reno, NV (US)

(21) Appl. No.: 17/114,436

(22) Filed: Dec. 7, 2020

(51) Int. Cl. G06N 3/08; G06F 30/27

(52) U.S. Cl. CPC G06N 3/08; G06F 2111/10; G06F 30/27

(57) ABSTRACT

A computer-implemented method, a computer program product, and a computer system for optimally balancing deployment of a deep learning based surrogate model and a physics based mathematical model in simulating a complex problem. One or more computing devices or servers compare results of running the deep learning based surrogate model with results of partially running the physics based mathematical model or with observations. One or more computing devices or severs output the results of running the deep learning based surrogate model as system outputs of simulating the complex problem, in response to determining that the deep learning based surrogate model is reliable. One or more computing devices or servers output results of running the physics based mathematical model as the system outputs of simulating the complex problem, in response to determining that the deep learning based surrogate model is not reliable.

### BACKGROUND

The present invention relates generally to using a deep learning based surrogate model in simulating a complex problem, and more particularly to optimally balancing deployment of a deep learning based surrogate model and a physics based mathematical model in simulating a complex problem.

Precise and detailed results from simulations using large-scale models or physics based models (for example simulations using partial differential equations) are critical to large number of applications (for example, weather forecasts and financial forecasts). These simulation models often rely on complex non-linear equations, and they require lots of computing power in the model-application phase.

Deep learning based surrogate models may be used, and they reduce the run-time of the model-application phase at a cost of increasing the run-time of the model-training phase. Deep learning based surrogate models can be considered as reduced order models; they are cheaper or computationally lightweight to be deployed and applied than large-scale models or physics based models. However, deep learning based surrogate models may be less accurate under certain conditions, particularly in case of extreme events which are sparse in training data. There is some work on developing surrogate models for partial differential equation models. Some approaches use some forms of model aggregation to combine outputs from multiple models, including combining outputs from physics based and surrogate models.

### SUMMARY

In one aspect, a computer-implemented method is provided. The computer-implemented method comprises running a deep learning based surrogate model for simulating a complex problem. The computer-implemented method further comprises partially running a physics based mathematical model for checking reliability of the deep learning based surrogate model. The computer-implemented method further comprises comparing results of running the deep learning based surrogate model with results of partially running the physics based mathematical model. The computer-implemented method further comprises determining whether the deep learning based surrogate model is reliable for simulating the complex problem. The computer-implemented method further comprises, in response to determining that the deep learning based surrogate model is reliable, outputting the results of running the deep learning based surrogate model as system outputs of simulating the complex problem. The computer-implemented method further comprises, in response to determining that the deep learning based surrogate model is not reliable, outputting results of running the physics based mathematical model as the system outputs of simulating the complex problem. Furthermore, the computer-implemented method comprises, in response to determining that the deep learning based surrogate model is not reliable, training the deep learning based surrogate model online, with a batch of the results of running the physics based mathematical model.

In another aspect, a computer program product is provided. The computer program product comprises a computer readable storage medium having program instructions embodied therewith, and the program instructions are executable by one or more processors. The program instructions are executable to: run a deep learning based surrogate model for simulating a complex problem; partially run a physics based mathematical model for checking reliability of the deep learning based surrogate model; compare results of running the deep learning based surrogate model with results of partially running the physics based mathematical model; determine whether the deep learning based surrogate model is reliable for simulating a complex problem; output the results of running the deep learning based surrogate model as system outputs of simulating the complex problem, in response to determining that the deep learning based surrogate model is reliable; and output results of running the physics based mathematical model as the system outputs of simulating the complex problem, in response to determining that the deep learning based surrogate model is not reliable. Furthermore, the program instructions are executable to, in response to determining that the deep learning based surrogate model is not reliable, train the deep learning based surrogate model online, with a batch of the results of running the physics based mathematical model.

In yet another aspect, a computer system is provided. The computer system comprises one or more processors, one or more computer readable tangible storage devices, and program instructions stored on at least one of the one or more computer readable tangible storage devices for execution by at least one of the one or more processors. The program instructions are executable to run a deep learning based surrogate model for simulating a complex problem. The program instructions are further executable to partially run a physics based mathematical model for checking reliability of the deep learning based surrogate model. The program instructions are further executable to compare results of running the deep learning based surrogate model with results of partially running the physics based mathematical model. The program instructions are further executable to determine whether the deep learning based surrogate model is reliable for simulating a complex problem. The program instructions are further executable to, in response to determining that the deep learning based surrogate model is reliable, output the results of running the deep learning based surrogate model as system outputs of simulating the complex problem. The program instructions are further executable to, in response to determining that the deep learning based surrogate model is not reliable, output results of running the physics based mathematical model as the system outputs of simulating the complex problem. Furthermore, the program instructions are executable to, in response to determining that the deep learning based surrogate model is not reliable, train the deep learning based surrogate model online, with a batch of the results of running the physics based mathematical model.

In yet another aspect, a computer-implemented method is provided. The computer-implemented method comprises comparing, in a previous time window, outputs of running a deep learning based surrogate model for simulating a complex problem with outputs of partially running a physics based mathematical model for checking reliability of the deep learning based surrogate model, in response to determining that, in a current time window, no output of partially running the physics based mathematical model is available. The computer-implemented method further comprises determining whether the deep learning based surrogate model is reliable for simulating the complex problem. The computer-implemented method further comprises running the deep learning based surrogate model and outputting results of running the deep learning model as system outputs of simulating the complex problem, in response to determining that the deep learning based surrogate model is reliable. The computer-implemented method further comprises running the physics based mathematical model and outputting results of running the physics based mathematical model as the system outputs of simulating the complex problem, in response to determining that the deep learning based surrogate model is not reliable.

In yet another aspect, a computer-implemented method is provided. The computer-implemented method comprises running a deep learning based surrogate model for simulating a complex problem. The computer-implemented method further comprises comparing results of running the deep learning based surrogate model with observation data of the complex problem. The computer-implemented method further comprises determining whether the deep learning based surrogate model is reliable for simulating the complex problem. The computer-implemented method further comprises, in response to determining that the deep learning based surrogate model is reliable, outputting the results of running the deep learning based surrogate model as system outputs of simulating the complex problem. The computer-implemented method further comprises, in response to determining that the deep learning based surrogate model is not reliable, running a physics based mathematical model and outputting results of running the physics based mathematical model as the system outputs of simulating the complex problem.

### BRIEF DESCRIPTION OF THE SEVERAL VIEWS OF THE DRAWINGS

FIG. 1 is a systematic diagram illustrating a system for optimally balancing deployment of a deep learning based surrogate models model and a physics based mathematical model in simulating a complex problem, in accordance with one embodiment of the present invention.

FIG. 2 presents a flowchart showing operational steps for optimally balancing deployment of a deep learning based surrogate models model and a physics based mathematical model in simulating a complex problem, in accordance with one embodiment of the present invention.

FIG. 3 is a diagram illustrating components of a computing device or server, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiments of the present invention disclose a method and system that optimally balances deployment of computationally expensive simulation models (or physics based models) and computationally cheap surrogate models based on defined performance (e.g., accuracy) requirements.

One embodiment discloses a system and methods that adopt an adversarial network approach to optimally select whether to run a surrogate model (which is computationally cheap to be deployed and applied) or to run a physics based model (for example a partial differential equation) for different forecast periods. The system and method provide online training of the surrogate model.

The present invention provides optimal usage of computing resources by balancing accuracy and complexity in model computation. The present invention provides a discriminator network approach to evaluate the performance of the deep learning based surrogate model; if a performance score is less than a given threshold, forecasts by the deep learning based surrogate model are replaced with high-fidelity forecasts by the physics based model (for example a partial differential equation), and furthermore the deep learning based surrogate model is updated via online training on high fidelity data of the physics based model.

The implementation of the present invention relies on a machine learning based classifier or comparison module. The machine learning based classifier or comparison module determines whether forecasts generated by the deep learning based surrogate model are similar to observations and/or partial outputs of the physics based model (e.g., the partial differential equation (PDE) model). The implementation of the present invention further relies on a module that switches between the deep learning based surrogate model and the physics based model such as the PDE model. In an embodiment, the machine learning based classifier or comparison module may work as the module for switching between the deep learning based surrogate model and the physics based model such as the PDE model. Furthermore, the implementation of the present invention relies on an online-training module that updates the deep learning based surrogate model based on newly available outputs from the physics based model such as the PDE model. The comparison module and the online-training module will be discussed in detailed in later paragraphs of this document.

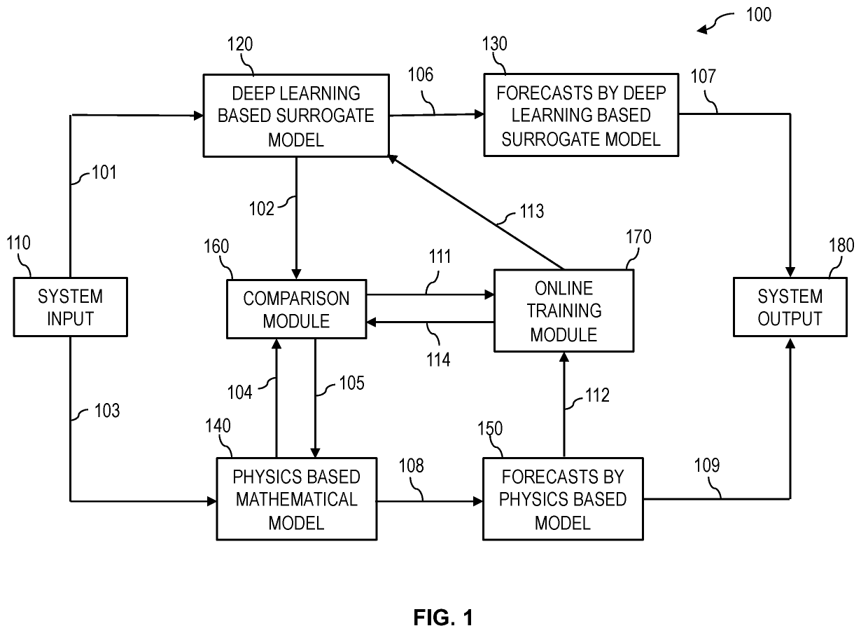

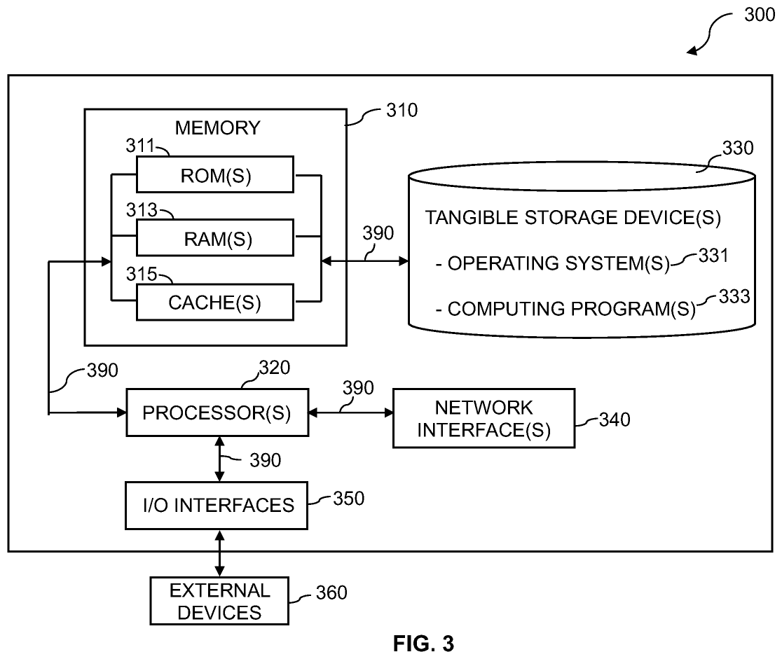

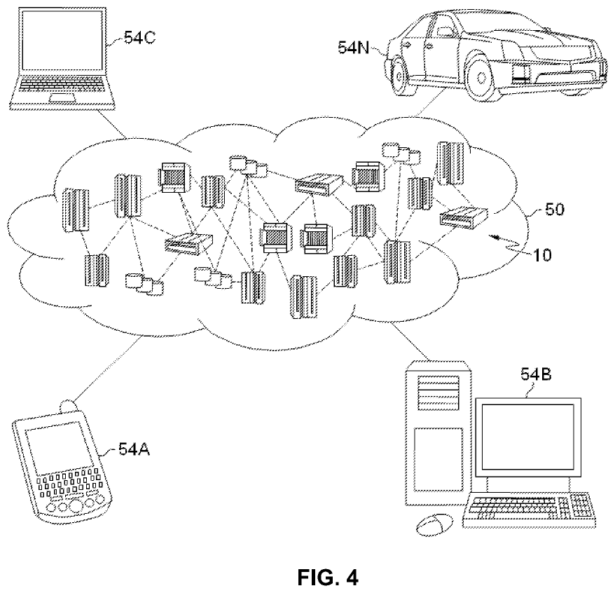

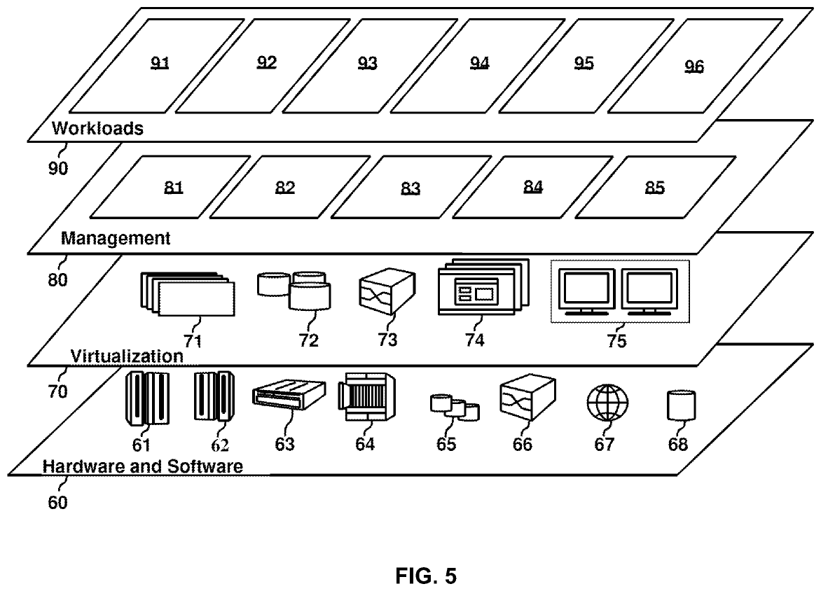

FIG. 1 is a systematic diagram illustrating system 100 for optimally balancing deployment of a deep learning based surrogate model and a physics based mathematical model in simulating a complex problem, in accordance with one embodiment of the present invention. System 100 is implemented on one or more computing devices or servers. A computing device or server may be any electronic device or computing system capable of receiving input from a user, executing computer program instructions, and communicating with another computing system via a network. A computing device or server is described in more detail in later paragraphs with reference to FIG. 3. System 100 may be implemented in a network that can be any combination of connections and protocols which support communications among the computing devices or servers. For example, the network may be the Internet which represents a worldwide collection of networks and gateways to support communications between devices connected to the Internet; the network may be implemented as an intranet, a local area network (LAN), a wide area network (WAN), or a wireless network. System 100 may be implemented in a cloud computing environment. The cloud computing environment is described in more detail in later paragraphs with reference to FIG. 4 and FIG. 5.

System 100 comprises deep learning based surrogate model 120 and physics based mathematical model 140. Both deep learning based surrogate model 120 and physics based mathematical model 140 can be used for simulating a complex problem such as weather forecasts or financial forecasts. For example, physics based mathematical model 140 may be a partial differential equation (PDE) model. An objective of system 100 lies in minimizing the load on physics based mathematical model 140 (e.g., a PDE simulator) for generating the forecasts, while at the same time ensuring that the forecasts are of sufficient accuracy. System 100 further comprises comparison module 160 and online training module 170.

Deep learning based surrogate model 120 is deployed in system 100, as a default choice for generating forecasts of a complex problem such as weather forecasts or financial forecasts. Deep learning based surrogate model 120 is a computationally lightweight version of physics based mathematical model 140 (e.g., a PDE). Deep learning based surrogate model 120 is trained offline by training a deep learning model as a generative model that can replicate outputs of physics based mathematical model 140 (e.g., a PDE simulator). Deep learning based surrogate model 120 is trained on a large volume of historical data from physics based mathematical model 140 (e.g., a PDE simulator). The offline training enables deep learning based surrogate model 120 to learn the physics of physics based mathematical model 140 (e.g., a PDE simulator). Once trained offline, deep learning based surrogate model 120 can be deployed for simulating a complex problem such as weather forecast or financial forecast.

In a most simplistic offline training of deep learning based surrogate model 120, the L²-norm and the Mahalanobis distance are metrics to compare errors or differences between two values (or array of values). The metrics like the L²-norm or the Mahalanobis distance are used by comparison module 160 to quantify the similarity between outputs of deep learning based surrogate model 120 and outputs of physics based mathematical model 140 (e.g., a PDE).

In one embodiment, deep learning based surrogate model 120 may be trained as a classical autoencoder with an L²-norm or with channel wise cosine-similarity. In another embodiment, deep learning based surrogate model 120 may be trained as a variational auto-encoder or as a generator in the generative adversarial network (GAN) framework. Although these models for training are more complex and require significant training effort, they can capture the distributions of high-dimensional data more effectively. Moreover, offline training of deep learning based surrogate model 120 is a one-time operation and consequently doesn't affect the run-time of deployed system 100.

Deep learning based surrogate model 120 may incorporate both spatial and temporal dynamics (such as a weather forecasting model). In offline training, deep learning based surrogate model 120 may be improved by conditioning on the both initial conditions and previously generated samples. These dynamics can be captured by models like cycle generative adversarial network (Cycle-GAN) which provides a framework to learn on previous values.

In system 100, while deep learning based surrogate model 120 is a default choice for generating forecasts of a complex problem such as weather forecasts or financial forecasts, physics based mathematical model 140 (e.g., a PDE) is partially run for checking reliability of deep learning based surrogate model 120. In one embodiment, physics based mathematical model 140 (e.g., a PDE) may run partially in time. For example, in weather forecasts, physics based mathematical model 140 makes a one-day forecast instead of a full 10-day forecast, and the one-day forecast may be used by comparison module 160 to evaluate the performance of deep learning based surrogate model 120 against the one-day forecast by physics based mathematical model 140. In another embodiment, physics based mathematical model 140 (e.g., a PDE) may run partially in space. For example, physics based mathematical model 140 (e.g., a PDE) is run where the dynamics of an object (such as an airplane) are resolved over one area (such as a wing tip). The results of partially running in space are used by comparison module 160 to evaluate the performance of deep learning based surrogate model 120.

The objective of comparison module 160 lies in computing a score that can quantify the similarity between forecasts generated by deep learning based surrogate model 120 and forecasts generated by physics based mathematical model 140 (e.g., the PDE). The objective of comparison module 160 also lies in accordingly seeking an occasional outputs from physics based mathematical model 140 (e.g., the PDE) for cases where the outputs of deep learning based surrogate model 120 begins to diverge from the forecasts of physics based mathematical model 140 (e.g., the PDE).

In an embodiment using a generative adversarial network (GAN) framework, while a generator serves as deep learning based surrogate model 120, a discriminator servers as comparison module 160. Contrary to conventional approaches like L²-norms, the GAN-discriminator or Cycle-GAN discriminator is a deep learning model itself and it is better suited to capture more implicit distributional properties pertaining to high-dimensional numerical data as arising, e.g., from weather forecast or finance forecast.

System input 110 is provided to deep learning based surrogate model 120, as indicated by arrow 101. System input 110 includes, for example, boundary conditions. System input 110 is also provided to physics based mathematical model 140 (e.g., a PDE simulator), as indicated by arrow 103. Comparison module 160 receives outputs of deep learning based surrogate model 120, as indicted by arrow 102. Comparison module 160 receives outputs of partially running physics based mathematical model 140 (e.g., a PDE simulator), as indicted by arrow 104. Comparison module 160 compares the outputs of deep learning based surrogate model 120 against the outputs of partially running physics based mathematical model 140 (e.g., a PDE simulator). Comparison module 160 computes a score of the reliability of the outputs of deep learning based surrogate model 120. Based on results of the comparison, comparison module 160 determines which one of deep learning based surrogate model 120 and physics based mathematical model 140 is used for simulating the complex problem such as weather forecast or financial forecast.

In another embodiment, the comparison is on the most recent forecast available from physics based mathematical model 140. If results of partially running physics based mathematical model 140 is not available in a current time window, comparison module 160 may compare the performance of deep learning based surrogate model 120 and available forecast from physics based mathematical model 140 both in a previous time window (such as the forecast for the previous day). It is a standard assumption that the skill of a model has some retention and that a model performs well yesterday likely performs well today and the performance of the model may degrade over time but not immediately. In yet another embodiment, comparison module 160 may compare the outputs of deep learning based surrogate model 120 against observation data of the complex problem such as weather forecasts and financial forecasts, avoiding the requirement for a partial run of physics based mathematical model 140.

In response to determines that deep learning based surrogate model 120 is reliable, system 100 uses forecasts 130 (by deep learning based surrogate model) as system output 180, as indicated by arrows 106 and 107. In response to determines that deep learning based surrogate model 120 is not reliable, comparison module 160 triggers physics based mathematical model 140 to be run, as indicated by arrow 105; system 100 uses forecast 150 (by physics based model) as system output 180, as indicated by arrows 108 and 109.

Online training module 170 is critical for updating deep learning based surrogate model 120, when a drift, divergence, or poor performance under low-probability inputs is reported by comparison module 160. In response to determines that deep learning based surrogate model 120 is not reliable, comparison module 160 triggers online training module 170, as indicated by arrow 111. Online training module 170 uses a small batch of most recent data of forecast 150 (as indicated by arrow 112) to update deep learning based surrogate model 120 (as indicated by arrow 113). Using online training, deep learning based surrogate model 120 is updated periodically by updating parameters of deep learning based surrogate model 120, with the most recent data from physics based mathematical model 140 (e.g., a PDE simulator). Online training is a method in machine learning that allows to update deep learning based surrogate model 120 with a small batch of data. Online training is more efficient than retraining the model on an entire dataset plus a small batch of new data.

Online training module 170 uses approaches, for example transfer learning or meta-learning. Transfer learning and meta-learning are broad subfields in machine learning, aiming to enable a machine learning model to either generalize new data better or learn from new data better. The new outputs obtained from physics based mathematical model 140 (e.g., a PDE simulator), i.e., the paired tuple of initial conditions/boundary conditions and simulated data, serve as new samples for updating deep learning based surrogate model 120. Algorithms like model-agnostic meta learning (MAML) may be used to update deep learning based surrogate model 120.

Furthermore, online training module 170 uses a small batch of data of physics based model forecast 150 (as indicated by arrow 113) to update comparison module 160 (as indicated by arrow 114). Updates for comparison module 160 may include recalibrating a score function used by comparison module 160. In case of a deep learning model, algorithms like model-agnostic meta learning (MAML) may be used. In an embodiment of using a GAN-type model, a discriminator as the comparison module is automatically updated within the adversarial framework of GAN. GAN is based on two models—a generator (as the surrogate model in the invention) and discriminator (as the comparison module in the invention); the generator and the discriminator compete against each other and they are updated online as part of the competition.

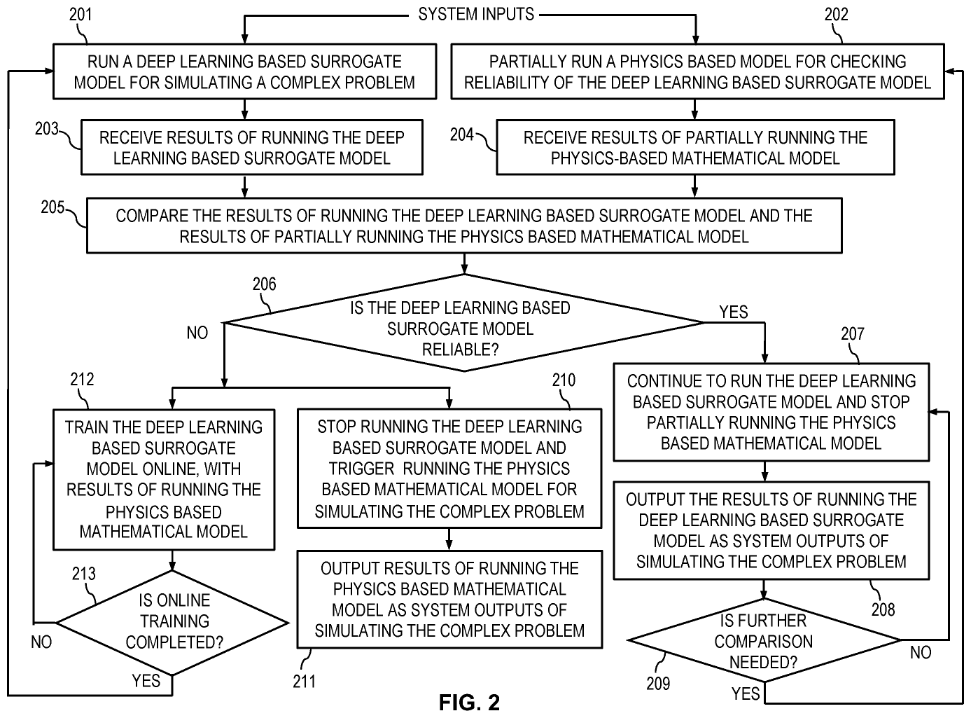

FIG. 2 presents a flowchart showing operational steps for optimally balancing deployment of a deep learning based surrogate model and a physics based mathematical model in simulating a complex problem, in accordance with one embodiment of the present invention. The operational steps are implemented by system 100 (shown in FIG. 1) which is hosted by one or more computing devices or servers.

Upon receiving system inputs (such as boundary conditions), the one or more computing devices or servers, at step 201, run a deep learning based surrogate model (for example deep learning based surrogate model 120 shown in FIG. 1) for simulating a complex problem. For example, the complex problems are weather forecasts or financial forecasts. The deep learning based surrogate model is trained offline on a large volume of historical data from a physics based mathematical model; once trained offline, the deep learning based surrogate model is deployed as a default choice for generating forecasts of the complex problem.

Using the system inputs, the one or more computing devices or servers, at step 202, partially run the physics based mathematical model (physics based mathematical model 140 shown in FIG. 1) for checking reliability of the deep learning based surrogate model. For example, the physics based mathematical model may be a partial differential equation. The physics based mathematical model may run partially in time, running for a short period time instead of a full time. The physics based mathematical model may run partially in space, running in a certain area where dynamics of an object can be resolved.

After step 201, the one or more computing devices or servers at step 203 receive results of running the deep learning based surrogate model. After step 202, the one or more computing devices or servers at step 204 receive results of partially running the physics based mathematical model. In the embodiment shown in FIG. 1, comparison module 160 receives the results of running the deep learning based surrogate model and results of partially running the physics based mathematical model.

After steps 203 and 204, the one or more computing devices or servers at step 205 compare the results of running the deep learning based surrogate model and the results of partially running the physics based model. In the embodiment shown in FIG. 1, comparison module 160 compare the results of running the deep learning based surrogate model and the results of partially running the physics based model. The one or more computing devices or servers compute a performance score that indicates the similarity between results generated by the deep learning based surrogate model and results generated by the physics based mathematical model. The performance score indicates whether the deep learning based surrogate model is reliable. To quantify the similarity between outputs of the deep learning based surrogate model and outputs of the physics based mathematical model, in one embodiment, comparison module 160 uses the metrics like the L²-norm or the Mahalanobis distance; in another embodiment, a generative adversarial network (GAN) framework is used in which a discriminator servers as comparison module 160.

Based on the performance score, at step 206, the one or more computing devices or servers determines whether the deep learning based surrogate model is reliable. In the embodiment shown in FIG. 1, comparison module 160 decides whether the deep learning based surrogate model provides a sufficient forecasting skill to be deployed in a forecasting mode.

In response to determining that the deep learning based surrogate model is reliable (YES branch of decision block 206), at step 207, the one or more computing devices or servers continue to run the deep learning based surrogate model and stop partially running the physics based mathematical model. The deep learning based surrogate model will continue to run as the default choice for generating forecasts of the complex problem, while the physics based mathematical model will not be triggered to be run for generating forecasts of the complex problem.

At step 208, the one or more computing devices or servers output the results of running the deep learning based surrogate model as system outputs of simulating the complex problem. At step 209, the one or more computing devices or servers determines whether further comparison is needed or whether further checking the reliability of the deep learning based surrogate model is needed.

In response to determining that further comparison is needed or checking the reliability of the deep learning based surrogate model is needed (YES branch of decision step 209), the one or more computing devices or servers reiterate step 202. The one or more computing devices or servers will restart partially running the physics based mathematical model.

In response to determining that further comparison is not needed or further checking the reliability of the deep learning based surrogate model is not needed (NO branch of decision step 209), the one or more computing devices or servers reiterate step 207. The deep learning based surrogate model will continue to be run for generating forecasts of the complex problem and its results will continue to be used as the system outputs of simulating the complex problem.

Referring back to decision step 206, in response to determining that the deep learning based surrogate model is not reliable (NO branch of decision block 206), at step 210, the one or more computing devices or servers stop running the deep learning based surrogate model and trigger running the physics based mathematical model for simulating the complex problem. The physics based mathematical model will take the place of the deep learning based surrogate model; the physics based mathematical model will not be partially run any more but fully run for generating forecasts of the complex problem. At step 211, the one or more computing devices or servers output results of running the physics based mathematical model as system outputs of simulating the complex problem.

Parallel to step 210, in response to determining that the deep learning based surrogate model is not reliable (NO branch of decision block 206), at step 212, the one or more computing devices or servers train the deep learning based surrogate model online, with a batch of the results of running the physics based mathematical model. The deep learning based surrogate model is updated periodically by updating parameters of the deep learning based surrogate model. In the embodiment shown in FIG. 1, online training module 170 uses a batch of the results of running the physics based mathematical model to train and update the deep learning based surrogate model. For example, online training module 170 may use transfer learning or meta-learning to update the deep learning based surrogate model.

At step 213, the one or more computing devices or servers determines whether online training of the deep learning based surrogate model is completed. In response to determining that the online training is not completed (NO branch of decision step 213), the one or more computing devices or servers reiterate step 212 to continue the online training. In response to determining that the online training is completed (YES branch of decision step 213), the one or more computing devices or servers reiterate step 201. The deep learning based surrogate model is again run as the default choice for generating forecasts of the complex problem.

FIG. 3 is diagram illustrating components of computing device or server 300, in accordance with one embodiment of the present invention. It should be appreciated that FIG. 3 provides only an illustration of one implementation and does not imply any limitations with regard to the environment in which different embodiments may be implemented.

Referring to FIG. 3, computing device or server 300 includes processor(s) 320, memory 310, and tangible storage device(s) 330. In FIG. 3, communications among the above-mentioned components of computing device or server 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computing device 300 further includes I/O interface(s) 350. I/O interface(s) 350 allows for input and output of data with external device(s) 360 that may be connected to computing device or server 300. Computing device or server 300 further includes network interface(s) 340 for communications between computing device or server 300 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of optimally balancing deployment of a deep learning based surrogate model and a physics based mathematical model in simulating a complex problem.

What is claimed is:

1. A computer-implemented method, the method comprising:
running a deep learning based surrogate model for simulating a complex problem;
partially running a physics based mathematical model for checking reliability of the deep learning based surrogate model;
comparing results of running the deep learning based surrogate model with results of partially running the physics based mathematical model;
determining whether the deep learning based surrogate model is reliable for simulating the complex problem;
in response to determining that the deep learning based surrogate model is reliable, outputting the results of running the deep learning based surrogate model as system outputs of simulating the complex problem; and
in response to determining that the deep learning based surrogate model is not reliable, outputting results of running the physics based mathematical model as the system outputs of simulating the complex problem.

2. The computer-implemented method of claim 1, further comprising:
in response to determining that the deep learning based surrogate model is not reliable, training the deep learning based surrogate model online, with a batch of the results of running the physics based mathematical model.

3. The computer-implemented method of claim 1, wherein the deep learning based surrogate model is trained offline before deployed as a default choice for simulating the complex problem, wherein the deep learning based surrogate model is trained offline with historical data from the physics based mathematical model.

4. The computer-implemented method of claim 1, further comprising:
computing a performance score that indicates similarity between the results of running the deep learning based surrogate model and the results of partially running the physics based mathematical model; and
wherein determining whether the deep learning based surrogate model is reliable is based on the performance score.

5. The computer-implemented method of claim 1, further comprising:
in response to determining that the deep learning based surrogate model is reliable, continuing to run the deep learning based surrogate model as a default choice for simulating the complex problem and stopping partially running the physics based mathematical model.

6. The computer-implemented method of claim 1, further comprising:
in response to determining that the deep learning based surrogate model is not reliable, stopping running the deep learning based surrogate model and triggering running the physics based mathematical model for simulating the complex problem.

7. A computer program product, the computer program product comprising a computer readable storage medium having program instructions embodied therewith, the program instructions executable by one or more processors, the program instructions executable to:
run a deep learning based surrogate model for simulating a complex problem;
partially run a physics based mathematical model for checking reliability of the deep learning based surrogate model;
compare results of running the deep learning based surrogate model with results of partially running the physics based mathematical model;
determine whether the deep learning based surrogate model is reliable for simulating the complex problem;
in response to determining that the deep learning based surrogate model is reliable, output the results of running the deep learning based surrogate model as system outputs of simulating the complex problem; and
in response to determining that the deep learning based surrogate model is not reliable, output results of running the physics based mathematical model as the system outputs of simulating the complex problem.

8. The computer program product of claim 7, further comprising the program instructions executable to:
in response to determining that the deep learning based surrogate model is not reliable, train the deep learning based surrogate model online, with a batch of the results of running the physics based mathematical model.

9. The computer program product of claim 7, wherein the deep learning based surrogate model is trained offline before deployed as a default choice for simulating the complex problem, wherein the deep learning based surrogate model is trained offline with historical data from the physics based mathematical model.

10. The computer program product of claim 7, further comprising program instructions executable to:
compute a performance score that indicates similarity between the results of running the deep learning based surrogate model and the results of partially running the physics based mathematical model; and
wherein determining whether the deep learning based surrogate model is reliable is based on the performance score.

11. The computer program product of claim 7, further comprising program instructions executable to:
in response to determining that the deep learning based surrogate model is reliable, continue to run the deep learning based surrogate model as a default choice for simulating the complex problem and stop partially running the physics based mathematical model.

12. The computer program product of claim 7, further comprising the program instructions executable to:
in response to determining that the deep learning based surrogate model is not reliable, stop running the deep learning based surrogate model and trigger running the physics based mathematical model for simulating the complex problem.

13. A computer system, the computer system comprising:
one or more processors, one or more computer readable tangible storage devices, and program instructions stored on at least one of the one or more computer readable tangible storage devices for execution by at least one of the one or more processors, the program instructions executable to:
run a deep learning based surrogate model for simulating a complex problem;
partially run a physics based mathematical model for checking reliability of the deep learning based surrogate model;
compare results of running the deep learning based surrogate model with results of partially running the physics based mathematical model;
determine whether the deep learning based surrogate model is reliable for simulating the complex problem;
in response to determining that the deep learning based surrogate model is reliable, output the results of running the deep learning based surrogate model as system outputs of simulating the complex problem; and
in response to determining that the deep learning based surrogate model is not reliable, output results of running the physics based mathematical model as the system outputs of simulating the complex problem.

14. The computer system of claim 13, further comprising the program instructions executable to:
in response to determining that the deep learning based surrogate model is not reliable, train the deep learning based surrogate model online, with a batch of the results of running the physics based mathematical model.

15. The computer system of claim 13, wherein the deep learning based surrogate model is trained offline before deployed as a default choice for simulating the complex problem, wherein the deep learning based surrogate model is trained offline with historical data from the physics based mathematical model.

16. The computer system of claim 13, further comprising program instructions executable to:
compute a performance score that indicates similarity between the results of running the deep learning based surrogate model and the results of partially running the physics based mathematical model; and
wherein determining whether the deep learning based surrogate model is reliable is based on the performance score.

17. The computer system of claim 13, further comprising program instructions executable to:
in response to determining that the deep learning based surrogate model is reliable, continue to run the deep learning based surrogate model as a default choice for simulating the complex problem and stop partially running the physics based mathematical model.

18. The computer system of claim 13, further comprising program instructions executable to:
in response to determining that the deep learning based surrogate model is not reliable, stop running the deep learning based surrogate model and trigger running the physics based mathematical model for simulating the complex problem.

19. A computer-implemented method, the method comprising:
in response to determining that, in a current time window, no output of partially running a physics based mathematical model is available, comparing, in a previous time window, outputs of running a deep learning based surrogate model for simulating a complex problem with outputs of partially running the physics based mathematical model for checking reliability of the deep learning based surrogate model;
determining whether the deep learning based surrogate model is reliable for simulating the complex problem;
in response to determining that the deep learning based surrogate model is reliable, running the deep learning based surrogate model and outputting results of running the deep learning model as system outputs of simulating the complex problem; and
in response to determining that the deep learning based surrogate model is not reliable, running the physics based mathematical model and outputting results of running the physics based mathematical model as the system outputs of simulating the complex problem.

20. The computer-implemented method of claim 19, further comprising:
in response to determining that the deep learning based surrogate model is not reliable, training the deep learning based surrogate model online, with a batch of the results of running the physics based mathematical model.

21. The computer-implemented method of claim 19, further comprising:
computing a performance score that indicates similarity between the results of running the deep learning based surrogate model and the results of partially running the physics based mathematical model; and
wherein determining whether the deep learning based surrogate model is reliable is based on the performance score.

22. The computer-implemented method of claim 19, further comprising:
in response to determining that the deep learning based surrogate model is reliable, continue to run the deep learning based surrogate model as a default choice for simulating the complex problem; and
in response to determining that the deep learning based surrogate model is not reliable, stop running the deep learning based surrogate model as the default choice for simulating the complex problem and trigger running the physics based mathematical model for simulating the complex problem.

23. A computer-implemented method, the method comprising:
running a deep learning based surrogate model for simulating a complex problem;
comparing results of running the deep learning based surrogate model with observation data of the complex problem;
determining whether the deep learning based surrogate model is reliable for simulating the complex problem;
in response to determining that the deep learning based surrogate model is reliable, outputting the results of running the deep learning based surrogate model as system outputs of simulating the complex problem; and
in response to determining that the deep learning based surrogate model is not reliable, running a physics based mathematical model and outputting results of running the physics based mathematical model as the system outputs of simulating the complex problem.

24. The computer-implemented method of claim 23, further comprising:
in response to determining that the deep learning based surrogate model is not reliable, training the deep learning based surrogate model online, with a batch of the results of running the physics based mathematical model.

25. The computer-implemented method of claim 23, further comprising:
computing a performance score that indicates similarity between the results of running the deep learning based surrogate model and the observation data of the complex problem; and
wherein determining whether the deep learning based surrogate model is reliable is based on the performance score.
